(19) United States
(12) Patent Application Publication
(10) Pub. No.: US 2026/0346645 A1
(43) Pub. Date: Nov. 5, 2026

(54) TIRE HAVING A RADIAL CARCASS REINFORCEMENT

(71) Applicant: COMPAGNIE GENERALE DES ETABLISSEMENTS MICHELIN, Clermont-Ferrand (FR)

(72) Inventors: KATIA BARAN, Clermont-Ferrand (FR); CATHERINE MOUGIN, Clermont-Ferrand (FR)

(21) Appl. No.: 19/099,292

(22) PCT Filed: Jul. 28, 2023
(86) PCT No.: PCT/FR2023/051202

§ 371 Date: Jan. 28, 2025

(30) Foreign Application Priority Data
Jul. 29, 2022 (FR) FR2207932

(51) Int. Cl. B60C 1/00; B60C 9/02; C08K 3/04; C08K 3/06; C08L 7/00

(52) U.S. Cl. CPC B60C 1/0041; B60C 9/02; C08K 3/04; C08K 3/06; C08L 7/00; C08L 2201/08; C08L 2312/00

(57) ABSTRACT

A tire having a radial carcass reinforcement comprises, between the reinforcing elements of the carcass reinforcement and the cavity of the tire, a rubber mixture comprising a composition based on: an isoprene elastomer; 40 to 70 phr of reinforcing fillers, including at least 10 phr of pyrolysis carbon black, preferably at least 30 phr of pyrolysis carbon black; a crosslinking system; and 0.7% to 4% by mass, relative to the total mass of the composition, of one or more antioxidants.

### FIELD OF THE INVENTION

The present invention relates to a tyre having a radial carcass reinforcement, more particularly to a tyre intended to equip vehicles that carry heavy loads and run at a sustained speed, such as lorries, tractors, trailers and buses, for example.

### TECHNOLOGICAL BACKGROUND

Generally, a tyre comprises a tread intended to come into contact with the ground via a tread surface, the two axial ends of which are connected via two sidewalls to two beads that provide the mechanical connection between the tyre and the rim on which it is intended to be mounted. A radial tyre further comprises a reinforcement made up of a crown reinforcement radially on the inside of the tread and of a carcass reinforcement radially on the inside of the crown reinforcement.

The rubber mixture, situated between the carcass reinforcement and the cavity of the tyre, more specifically between the carcass reinforcement and the airtight layer of the tyre, must be both a chemical and physical barrier to oxygen in order to limit the diffusion of oxygen into the tyre. The rubber mixture must therefore be able to react with oxygen (chemical barrier) and be impermeable to oxygen (physical barrier).

By limiting the diffusion of oxygen in the lower region and/or in the crown of the tyre, this rubber mixture contributes to the endurance of the tyre.

It is known to those skilled in the art that the reactivity to oxygen of a mixture results in the degradation of some of these properties in the long term, such as, for example, an increase in the stiffness or the reduction in the elongation at break. The degradation of properties can cause weakening of the mixture under high stresses and ultimately degradation of the endurance of the tyre.

It is also known that one way to limit this thermal-oxidative degradation is to use antioxidants in order to limit the formation of R. or ROO. radicals. In return, however, the ability of the mixture to react with oxygen decreases. One way to increase the reactivity with oxygen would be to increase the sulfur content, but as a result there would be a greater risk of nodule formation during the shaping of the mixture due to a reduction in the curing to of the mixture.

Thus, there remains a need for the provision of a rubber mixture, able to be placed between the carcass reinforcement and the cavity of a tyre, more specifically between the carcass reinforcement and the airtight layer of the tyre, that has better resistance to thermal-oxidative degradation without reducing the ability thereof to react with oxygen and without reducing the curing value to of the mixture. Advantageously, the proposed solution will make it possible to reduce the environmental footprint of tyres having a radial carcass reinforcement by incorporating a significant and even greater portion of recycled materials.

### BRIEF DESCRIPTION OF THE INVENTION

The present invention relates to a tyre having a radial carcass reinforcement made up of at least one layer of reinforcing elements, the tyre comprising a crown reinforcement, itself capped radially by a tread, the tread being joined to two beads via two sidewalls, characterized in that the tyre comprises, between the reinforcing elements of the carcass reinforcement and the cavity of the tyre, a rubber mixture, said rubber mixture comprising a composition based on:
an isoprene elastomer;
40 to 70 phr of reinforcing fillers, including at least 10 phr of pyrolysis carbon black, preferably at least 30 phr of pyrolysis carbon black;
a crosslinking system; and
0.7% to 4% by mass, relative to the total mass of the composition, of one or more antioxidants.

Other aspects of the invention are as described below and in the claims.

### DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The expression “part by weight per hundred parts by weight of elastomer” (or phr) should be understood as meaning the part by mass per hundred parts by mass of elastomer or of rubber, the two terms being synonyms.

In the present document, unless expressly indicated otherwise, all the percentages (%) indicated are percentages (%) by mass.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is described by the expression “from a to b”, the interval represented by the expression “between a and b” is also and preferentially described.

The expression “radial” refers to a radius of the tyre. It is within this meaning that a point P1 is said to be “radially interior” to a point P2 (or “radially inside” the point P2) if it is closer to the axis of rotation of the tyre than the point P2. Conversely, a point P3 is said to be “radially exterior to” a point P4 (or “radially outside” the point P4) if it is further away from the axis of rotation of the tyre than the point P4. Progress will be said to be “radially inwards (or outwards)” when it is in the direction of the smaller (or larger) radii. This sense of the term also applies when it is a matter of radial distances.

The term “radial cross section” or “radial section” is understood here to mean a cross section or a section along a plane that contains the axis of rotation of the tyre.

An “axial” direction is a direction parallel to the axis of rotation of the tyre. A point P5 is said to be “axially interior” to a point P6 (or “axially inside” the point P6) if it is closer to the median plane of the tyre than the point P6. Conversely, a point P7 is said to be “axially exterior to” a point P8 (or “axially outside” the point P8) if it is further from the median plane of the tyre than the point P8. The “median plane” of the tyre is the plane that is perpendicular to the axis of rotation of the tyre and that is located equidistantly from the annular reinforcing structures of each bead.

A “circumferential” direction is a direction that is perpendicular both to a radius of the tyre and to the axial direction.

The compounds comprising carbon mentioned in the description may be of fossil or biobased origin. In the latter case, they may be partially or completely derived from biomass or obtained from renewable raw materials derived from biomass. This particularly concerns polymers, plasticizers, fillers, etc.

The curing to of a rubber mixture denotes the time that enables the processability of the mixture before the formation of crosslinking bridges (induction time).

### DETAILED DESCRIPTION OF THE INVENTION

Surprisingly, the inventors have discovered that the use of pyrolysis carbon black in a rubber mixture makes it possible to increase the contents of antioxidants in said mixture without degrading the ability of the mixture to react with oxygen and without reducing the curing t0 of the mixture.

Thus, the present invention relates to a tyre having a radial carcass reinforcement made up of at least one layer of reinforcing elements, the tyre comprising a crown reinforcement, itself capped radially by a tread, the tread being joined to two beads via two sidewalls, characterized in that the tyre comprises, between the reinforcing elements of the carcass reinforcement and the cavity of the tyre, a rubber mixture, said rubber mixture comprising, or consisting of, a composition based on:
an isoprene elastomer;
40 to 70 phr of reinforcing fillers, including at least 10 phr of pyrolysis carbon black, preferably at least 30 phr of pyrolysis carbon black;
a crosslinking system; and
0.7% to 4% by mass, preferably from 0.8% to 4% by mass, of one or more antioxidants relative to the total mass of the composition.

The composition may further comprise usual additives and processing aids.

The various constituents of the composition may be as described below.

### Elastomer

The composition of use in the context of the present invention is based on an isoprene elastomer.

The term “isoprene elastomer” is understood, in a known manner, to mean an isoprene homopolymer or copolymer, in other words an elastomer selected from the group consisting of natural rubber (NR), synthetic polyisoprenes (IRs), isoprene copolymers (e.g. copolymer of isobutene and of isoprene) and mixtures thereof.

Preferably, the composition of use in the context of the present invention is based on an isoprene elastomer selected from the group consisting of natural rubber, synthetic polyisoprenes and mixtures thereof. The elastomer thus typically consists of 70 to 100 phr of natural rubber and of 0 to 30 phr of synthetic polyisoprenes.

In certain embodiments, the composition of use in the context of the present invention is based on natural rubber. In other words, the composition does not comprise any other elastomers.

### Reinforcing Filler

The composition of use in the context of the present invention comprises from 40 to 70 phr of reinforcing fillers, including at least 10 phr of pyrolysis carbon black, preferably at least 30 phr of pyrolysis carbon black.

The term “reinforcing filler” denotes any type of filler known for its abilities to reinforce a rubber composition that can be used in particular for the manufacture of tyres, for example organic fillers such as carbon black or pyrolysis carbon black, or inorganic fillers such as silica or alumina.

In addition to the pyrolysis carbon black, the composition may therefore also comprise an inorganic reinforcing filler (e.g. silica or alumina) or an organic reinforcing filler such as carbon black so as to achieve a total content of reinforcing fillers ranging from 40 to 70 phr.

In certain embodiments, the composition comprises from 40 to 70 phr of reinforcing fillers, the reinforcing fillers being pyrolysis carbon black. It should thus be understood that the composition comprises the pyrolysis carbon black as the only reinforcing fillers (the composition therefore does not comprise any inorganic reinforcing fillers and other organic reinforcing fillers).

The reinforcing fillers may be as described below.

### Pyrolysis Carbon Black

The composition of use in the context of the invention comprises at least 10 phr of pyrolysis carbon black, preferably at least 30 phr of pyrolysis carbon black.

In certain embodiments, the composition comprises from 40 to 70 phr of pyrolysis carbon black.

For the purposes of the present invention, the term “pyrolysis carbon black” is understood to mean a carbon black resulting from a pyrolysis process of a material comprising at least a carbon-based polymer and a carbon black, hereinafter the material to be pyrolysed, for example in the context of the recycling of such a material. The physical state in which the material to be pyrolysed is provided is not important, whether it is in the form of a powder, granules, a strip, or any other form, in the crosslinked or noncrosslinked state.

Preferentially, the material to be pyrolysed may be recovered from manufactured articles or from products generated during their manufacture/production (such as by-products or scraps); these manufactured articles being able to be selected from the group consisting of pneumatic tyres, non-pneumatic tyres, industrial conveyor belts, transmission belts, rubber seals, rubber hoses, shoe soles and windscreen wipers. More preferentially still, the pyrolysis carbon black of use in the context of the present invention is a carbon black obtained from a pyrolysis process of which the material to be pyrolysed is derived from manufactured articles selected from the group consisting of pneumatic tyres and non-pneumatic tyres.

In the context of the present invention, “pyrolysis” means any type of thermal decomposition in the absence of oxygen and the raw material of which is the material to be pyrolysed as defined above. Pyrolysis carbon blacks thus differ from “industrial” and/or “ASTM-grade” carbon blacks in that the carbon-based raw material used for the pyrolysis is a material comprising at least a carbon-based polymer and a carbon black and not materials derived from petroleum cuts or derived from coal or else from oils of natural origin.

Pyrolysis carbon blacks usable in the context of the present invention differ from carbon blacks known as industrial carbon blacks, in particular “furnace” carbon blacks, in particular by a higher ash content.

Preferentially, the pyrolysis carbon black usable in the context of the present invention has an ash content ranging from 5% to 30% by weight, more preferentially ranging from 8% to 25% by weight, even more preferentially ranging from 10% to 22% by weight, relative to the total weight of the pyrolysis carbon black.

Preferentially, the pyrolysis carbon black usable in the context of the present invention has a sulfur content of greater than 2% by weight, preferably ranging from 2.5% to 5% by weight, relative to the total weight of the pyrolysis carbon black.

Preferentially, the pyrolysis carbon black usable in the context of the present invention has a zinc content of greater than or equal to 2% by weight, preferably ranging from 2.5% to 8% by weight, relative to the total weight of the pyrolysis carbon black.

Preferentially, the pyrolysis carbon black usable in the context of the present invention has an STSA specific surface area measured in accordance with Standard ASTM D 6556-2021 within a range extending from 20 to 200 m²/g, more preferentially extending from 30 to 90 m²/g.

Preferentially, the pyrolysis carbon black usable in the context of the present invention has an empty volume measured in accordance with Standard ASTM D7854 (2018) and at a pressure of 50 MPa within a range extending from 30 to 60 ml/100 g, more preferentially extending from 35 to 55 ml/100 g.

The ash content is determined by calcination in platinum dishes in a muffle furnace at 825 °C according to the following protocol. A dish is identified in advance before each series of measurements and is tared to within 0.1 mg and the mass is denoted P0. 5 g of pyrolysis carbon black sample is introduced into the dish, which is weighed precisely to within 0.1 mg; this mass is denoted P1. The dish and its contents are pre-calcined using a Bunsen burner until smoke appears and the product ignites. Once combustion of the product is complete, the dish and its contents are introduced into a muffle furnace heated to 825 °C for 1 h. After 1 h, the dish is removed from the furnace and immediately introduced into a desiccator at ambient temperature. When the dish and the ashes have returned to ambient temperature, the dish is weighed again to obtain the mass P2. Finally, it is possible to obtain the ash content (% ash) using the formula below:

$$\% ash = \frac{P 2 - P 0}{P 1 - P 0} \times 100$$

The content of zinc in the pyrolysis carbon black is realized after calcination of the sample, then take-up of the ashes in an acidic medium and assay by ICP-AES (inductively coupled plasma atomic emission spectroscopy). The ashes are obtained by carrying out the protocol above. About exactly 100 mg of ashes are taken (test sample) and introduced into a PFA (perfluoroalkoxy) tube for a HotBlock hot plate. 8 ml of 37% concentrated hydrochloric acid, 3 ml of 65% concentrated nitric acid and 0.5 ml of 40% hydrofluoric acid are then added. The tube is closed with its stopper and is heated to 130 °C for 2 h. After cooling, the contents are then transferred using ultrapure water into a 100 ml PTFE (polytetrafluoroethylene) volumetric flask already containing 2 g of boric acid (to neutralize the hydrofluoric acid). Ultrapure water is added up to the graduation mark. The solution obtained is diluted by 100, by taking 1 ml into a 100 ml PFTE flask already containing 8 ml of 37% concentrated hydrochloric acid, 3 ml of 65% concentrated nitric acid, 0.5 ml of 40% hydrofluoric acid and 2 g of boric acid. This diluted solution is then filtered on a 0.45 μm GHP syringe filter before being analysed by inductively coupled plasma atomic emission spectroscopy (ICP-AES). Prior to the analysis of the diluted solution, at least 5 standards are analysed by ICP-AES at zinc concentrations of 0, 0.5, 1, 2 and 5 mg/l. These standards were prepared in 100 ml volumetric flasks, by dilution of a commercial solution certified to a zinc concentration of 1 g/l.

These volumetric flasks already contain 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λZn=202.613 nm. For each standard concentration (c), the intensity of the zinc signal IZn is plotted on a graph IZn=f (c), which corresponds to the calibration straight line (of type y=ax+b). The solution of the sample (diluted solution) of unknown concentration is then measured under the same conditions as the standards. The measured intensity is linked to the concentration using the previously obtained calibration straight line. The concentration [c]ashes in % by mass is thus obtained directly by the software, since the test sample and the volume have been previously recorded. The concentration of zinc in the pyrolysis black [c]black in % by mass is obtained by the following equation:

[C]_{pack}=[C]ₐₛₕ*100*% ash

The content of sulfur in the pyrolysis carbon blacks is determined using a LECO furnace. LECO sulfur analysers are designed to measure, in particular, the content of sulfur in organic and/or inorganic materials by combustion and nondispersive infrared detection. Before measuring the content of sulfur in the sample, the boats are cleaned and the furnace is calibrated. The boats for the LECO furnace are cleaned beforehand: this involves analysing the empty boat, under the same conditions as the samples. The calibration curve is prepared using a commercial standard called “BBOT” having a purity of greater than 99.99% and a guaranteed content of carbon (C), hydrogen (H), nitrogen (N), oxygen (O) and sulfur(S). This content is as follows: C %: 72.52; H % 6.09; N % 6.51; O % 7.43 and S % 7.44. About exactly 10±3, 20±3 and 40±3 mg of BBOT are weighed into a boat. The standard/boat assembly is introduced into the combustion furnace, regulated at 1350 °C under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn.

The sulfur and/or the carbon, in the form of SO₂(g), are entrained by a stream of oxygen through the infrared detection cells. The instrument software plots a straight line linking the mass of standard introduced and the observed response (area) on the detector. A calibration straight line is thus obtained. After having carefully cleaned the sampling equipment, about exactly 80±5 mg of pyrolysis carbon black is weighed and introduced into a boat for the LECO furnace. The observed area of the SO₂ peak is linked to the concentration using the calibration straight line. Using the mass of sample introduced into the boat, the instrument software then calculates the % by mass of sulfur in the sample.

Pyrolysis carbon blacks are sold for example by BlackBear under the reference “BBCT30” or by Scandinavian Enviro Systems under the reference “P550”.

### Carbon Black

The composition of use in the context of the invention may comprise carbon black. Suitable carbon blacks are all carbon blacks, notably the blacks conventionally used in tyres or their treads, in particular industrial carbon blacks, more specifically “furnace” carbon blacks.

Among the carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. Preferably, the carbon blacks are selected from the group consisting of the blacks of the 300, 500, 600 and 700 series. The carbon blacks can be used in the isolated state, as available commercially, or in any other form, for example as support for some of the rubber additives used. The carbon blacks might, for example, be already incorporated in the diene elastomer, in particular isoprene elastomer, in the form of a masterbatch (see, for example, applications WO 97/36724-A2 or WO 99/16600-A1).

### Reinforcing Inorganic Filler

The composition of use in the context of the invention may comprise a reinforcing inorganic filler.

The term “reinforcing inorganic filler” should be understood here as meaning any inorganic or mineral filler, whatever its colour and its origin (natural or synthetic), also known as “white” filler, “clear” filler or even “non-black” filler, in contrast to carbon black, which is capable of reinforcing, by itself alone, without means other than an intermediate coupling agent, a rubber composition intended for the manufacture of tyres. In a known manner, certain reinforcing inorganic fillers can be characterized in particular by the presence of hydroxyl (—OH) groups at their surface.

Mineral fillers of the siliceous type, preferentially silica (SiO₂), or of the aluminous type, especially alumina (Al₂O₃), are suitable in particular as reinforcing inorganic fillers. The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g.

Use may be made of any type of precipitated silica, in particular highly dispersible precipitated silicas (HDS, for “highly dispersible silica”). These precipitated silicas, which may or may not be highly dispersible, are well known to those skilled in the art. Mention may be made, for example, of the silicas described in applications WO03/016215-A1 and WO03/016387-A1. Among the commercial HDS silicas, use may notably be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The BET specific surface area of the silica is determined in a known manner by gas adsorption using the Brunauer-Emmett-Teller method described in “The Journal of the American Chemical Society”, Vol. 60, page 309, February 1938, more specifically in accordance with French Standard NF ISO 9277 of December 1996 (multipoint (5 point) volumetric method-gas: nitrogen-degassing: 1 hour at 160 °C—relative pressure p/po range: 0.05 to 0.17). The CTAB specific surface area of the silica is determined in accordance with French Standard NF T 45-007 of November 1987 (method B).

As other examples of inorganic fillers that can be used in the compositions, mention may also be made of mineral fillers of the aluminous type, in particular alumina (Al₂O₃), aluminium oxides, aluminium hydroxides, aluminosilicates, titanium oxides, silicon carbides or nitrides, all of the reinforcing type as described for example in applications WO 99/28376-A2, WO 00/73372-A1, WO 02/053634-A1, WO 2004/003067-A1, WO 2004/056915-A2, U.S. Pat. No. 6,610,261-B1 and U.S. Pat. No. 6,747,087-B2. Mention may in particular be made of the aluminas Baikalox A125 or CR125 (Baïkowski), APA-100RDX (Condéa), Aluminoxid C (Evonik) or AKP-G015 (Sumitomo Chemicals).

The physical state in which the reinforcing inorganic filler is provided is not important, whether it is in the form of a powder, of micropearls, of granules or else of beads or any other appropriate densified form. Of course, the term “reinforcing inorganic filler” is also understood to mean mixtures of different reinforcing inorganic fillers, in particular of silicas as described above.

Those skilled in the art will understand that, as a replacement for the reinforcing inorganic filler described above, a reinforcing filler of another nature may be used, provided that this reinforcing filler of another nature is covered with an inorganic layer such as silica, or includes on its surface functional sites, in particular hydroxyl sites, requiring the use of a coupling agent to establish the bond between this reinforcing filler and the diene elastomer. By way of example, mention may be made of carbon blacks partially or totally covered with silica, or carbon blacks modified with silica, such as, but not limited to, fillers of the Ecoblack® type in the CRX2000 series or in the CRX4000 series from Cabot Corporation.

Those skilled in the art will know how to adjust the total content of reinforcing filler according to the use concerned, in particular according to the type of tyres concerned, for example a tyre for a motorbike, for a passenger vehicle or for a utility vehicle, such as a van or heavy-duty vehicle.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate sold by Momentive under the name NXT Silane. More preferentially, the organosilane is an organosilane polysulfide.

Those skilled in the art can find coupling agent examples in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

The content of coupling agent preferentially represents from 0.5% to 15% by weight relative to the amount of reinforcing inorganic filler, preferably from 4% to 12%, more preferably from 6% to 10%, by weight relative to the amount of reinforcing inorganic filler. Typically, the content of coupling agent is less than 20 phr, preferentially within a range extending from 6 to 17 phr, preferably from 8 to 15 phr. This content can easily be adjusted by those skilled in the art according to the content of inorganic filler used in the composition.

The composition may also comprise, in addition to the coupling agents, coupling activators, agents for covering the inorganic fillers or more generally processing aids capable, in a known manner, by virtue of an improvement in the dispersion of the filler in the rubber matrix and of a lowering in the viscosity of the compositions, of improving their ease of processing in the raw state, these processing aids being, for example, hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxypolyorganosiloxanes (in particular α,ω-dihydroxypolydimethylsiloxanes), or fatty acids, such as, for example, stearic acid.

### Other Organic Fillers

The composition of use in the context of the invention may comprise a reinforcing organic filler of functionalized polyvinyl type as described in applications WO 2006/069792-A1, WO 2006/069793-A1, WO 2008/003434-A1 and WO 2008/003435-A1.

### Crosslinking System

The composition of use in the context of the invention comprises a crosslinking system. The crosslinking system may be any type of system known to those skilled in the art in the field of rubber compositions for tyres. It may in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used at a preferential content of between 0.5 and 12 phr, in particular between 1 and 10 phr, preferably between 2 and 9 phr.

The vulcanization accelerator is used at a preferential content of between 0.1 and 10 phr, more preferentially between 0.3 and 1.0 phr.

The vulcanization activator is used at a preferential content of between 1 and 10 phr, more preferentially between 3.3 and 10 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and the mixtures of these compounds.

### Antioxidants

The composition of use in the context of the present invention comprises from 0.7% to 4% by mass, preferably from 0.8% to 4% by mass, relative to the total mass of the composition, of one or more antioxidants.

The antioxidant may be of the following type: amine, phenol, imidazole, para-phenylenediamine(s) and/or dihydrotrimethylquinoline(s), polymerized quinine, wax or any other antioxidant normally used in elastomer formulations.

As specific examples, mention may be made of: N-(1,3-dimethylbutyl)-N′-phenyl-p-phenylenediamine (6-PPD, sold for example under the brands ANTIGENER 6C by Sumitomo Chemical Co., Ltd. and NOCLAC® 6C by Ouchi Shinko Chemical Industrial Co., Ltd.), the product “Ozonon” 6C sold by Seiko Chemical Co., Ltd., polymerized 1,2-dihydro-2,2,4-trimethylquinoline (TMQ, sold for example under the brand Agerite Resin D, by R. T. Vanderbilt), butylhydroxytoluene (BHT), and butylhydroxyanisole (BHA).

The antioxidant is advantageously an N-alkyl-N′-phenyl-para-phenyldiamine corresponding to formula (I):

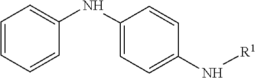

in which R¹ represents a linear or branched alkyl group having from 1 to 12 carbon atoms or a cycloalkyl group having from 5 to 8 carbon atoms.

Preferably, R¹ represents an alkyl having from 2 to 8 carbon atoms, preferentially selected from the group consisting of ethyl, propyl (i.e. n-propyl, isopropyl), butyl (i.e. n-butyl, sec-butyl and tert-butyl), pentyl, hexyl, heptyl and octyl, or a cycloalkyl group having from 5 to 8 carbon atoms (cyclopentyl, cyclohexyl, cycloheptyl, cyclooctyl), more preferentially a cyclohexyl group.

Use is more preferentially made of compounds for which the R¹ groups are branched, of formula (I-a) below:

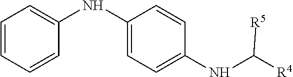

in which R⁴, R⁵, which are identical to or different from one another, each represent an alkyl group, the number of carbon atoms of which is in accordance with the preferential definitions given above for R¹.

As more preferential examples of branched R¹ radicals, mention will in particular be made of isopropyl, 1,3-dimethylbutyl and 1,4-dimethylpentyl.

The compounds of formula (I-a) above are well known to those skilled in the art. They have been used for a very long time as anti-ageing protection agents in rubber compositions for tyres, in particular in the belts of such tyres, and belong to the family of para-phenylenediamine (“PPD”) derivatives such as for example
N-isopropyl-N′-phenyl-para-phenylenediamine (“I-PPD”)

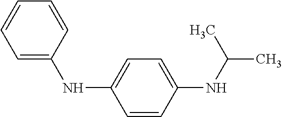 [SMILES: CC(C)Nc1ccc(Nc2ccccc2)cc1]

or N-1,3-dimethylbutyl-N′-phenyl-para-phenylenediamine (“6-PPD”)

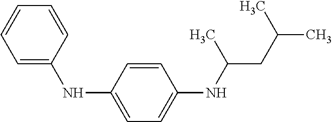 [SMILES: CC(C)CC(C)Nc1ccc(Nc2ccccc2)cc1]

(see for example applications WO 2004/033548, WO 2005/063510, WO 2005/133666).

### Usual Additives and Processing Aids

The composition of use in the context of the invention may also comprise all or some of the usual additives and processing aids known to those skilled in the art and customarily used in rubber compositions for tyres, such as, for example, plasticizers (such as plasticizing oils and/or plasticizing resins), non-reinforcing fillers, pigments, green tack promoting agents (i.e. tackifying agent, for example rosin), pro-oxidant metal salts, protective agents such as anti-ozone waxes, chemical anti-ozonants, anti-fatigue agents, reinforcing resins (as described, for example, in application WO 02/10269).

In certain embodiments, the composition of use in the context of the invention comprises more than 0 to 5 phr of a green tack promoting agent, for example from 1 to 5 phr of a green tack promoting agent.

In certain embodiments, the composition of use in the context of the present invention comprises one or more pro-oxidant metal salts, the content of which determined on the basis of the metal element varies from 0.05 to 0.15 g of metal per 100 g of the composition or from 0.07 to 0.15 g of metal per 100 g of the composition.

A pro-oxidant metal salt accelerates oxygen fixation by catalysing oxidation. Such salts are well known to those skilled in the art. Examples of pro-oxidant metal salts include, in a nonlimiting manner, cobalt salts, in particular cobalt salts selected from the group consisting of abietates, acetylacetonates, tallates, naphthenates, resinates and mixtures thereof, manganese salts or iron salts (e.g.: iron (III) salts as described in WO 99/24502 or WO 00/68309).

In certain embodiments, the composition of use in the context of the invention is a composition based on:
an isoprene elastomer;
40 to 70 phr of reinforcing fillers, including at least 10 phr of pyrolysis carbon black, preferably at least 30 phr of pyrolysis carbon black;
a crosslinking system, preferably the crosslinking system (e.g. a vulcanization system) comprising:
   between 0.5 and 12 phr, in particular between 1 and 10 phr, preferably between 2 and 9 phr, of sulfur;
   between 0.1 and 10 phr, preferentially between 0.3 and 1.0 phr, of one or more vulcanization accelerators;
   between 1 and 10 phr, preferentially between 3.3 and 10 phr, of one or more vulcanization activators;
0.7% to 4% by mass, relative to the total mass of the composition, of one or more antioxidant(s), preferably from 0.8% to 4% by mass; and
one or more pro-oxidant metal salts, the content of which determined on the basis of the metal varies from 0.05 to 0.15 g of metal per 100 g of the composition or from 0.07 to 0.15 g of metal per 100 g of the composition.

### Manufacture of the Compositions

The composition of use in the context of the invention is manufactured in appropriate mixers using two successive preparation phases that are well known to those skilled in the art:
a first phase of thermomechanical working or kneading (“non-productive” phase), which can be carried out in a single thermomechanical step during which all the necessary constituents, in particular the elastomeric matrix, the fillers, and the various other optional additives, with the exception of the crosslinking system, are introduced into an appropriate mixer, such as a standard internal mixer (for example of ‘Banbury’ type). The incorporation of the filler into the elastomer may be performed in one or more portions while thermomechanically kneading. In the case where the filler is already incorporated, totally or partially, into the elastomer in the form of a masterbatch, as is described, for example, in applications WO 97/36724 or WO 99/16600, it is the masterbatch that is directly kneaded and, where appropriate, the other elastomers or fillers present in the composition that are not in masterbatch form, and also the various other optional additives, with the exception of the crosslinking system, are incorporated.

The non-productive phase is carried out at high temperature, up to a maximum temperature of between 130 °C and 170 °C, for a period of time generally of between 2 and 10 minutes.
a second phase of mechanical working (“productive” phase), which is carried out in an external mixer, such as an open mill, after cooling the mixture obtained during the non-productive first phase down to a lower temperature, typically less than 110 °C, for example between 40 °C and 100 °C. The crosslinking system is then incorporated and the combined mixture is then mixed for a few minutes, for example between 1 and 30 min.

The final composition thus obtained is then calendered, for example in the form of a sheet or of a slab, in particular for laboratory characterization, or else is extruded in the form of a rubber semi-finished product (or profiled element) which can be used, for example, as an internal layer in a tyre.

The composition may be either in the uncured state (before crosslinking or vulcanization) or in the cured state (after crosslinking or vulcanization), or may be a semi-finished product which can be used in a tyre.

The crosslinking of the composition can be carried out in a manner known to those skilled in the art, for example at a temperature of between 130 °C and 200 °C, preferably under pressure, for a sufficient time which can vary, for example, between 5 and 90 min.

### Tyres

The compositions described above are especially useful for forming the inner wall of a tyre having a radial carcass reinforcement, more particularly for being arranged between the reinforcing elements of the carcass reinforcement and the cavity of the tyre, even more specifically between the reinforcing elements of the carcass reinforcement and the airtight layer of the tyre.

In certain embodiments, the tyre of the present invention as described above is characterized in that the rubber mixture between the cavity of the tyre and the reinforcing elements of the carcass reinforcement consists of at least two layers of rubber mixture, the layer of rubber mixture radially adjacent to the radially innermost layer of rubber mixture comprising, or consisting of, a composition as described above. In other words, the layer of rubber mixture comprising, or consisting of, a composition as described above is situated between the carcass reinforcement and the airtight layer of the tyre (radially innermost layer of rubber mixture). The tyres targeted by the invention are therefore tyres comprising, in addition to the carcass reinforcement and the airtight layer, an additional layer of rubber mixture as described above. Thus, this layer is not in direct contact with the air.

The tyre of the present invention may be as described with reference to the figures that follow:

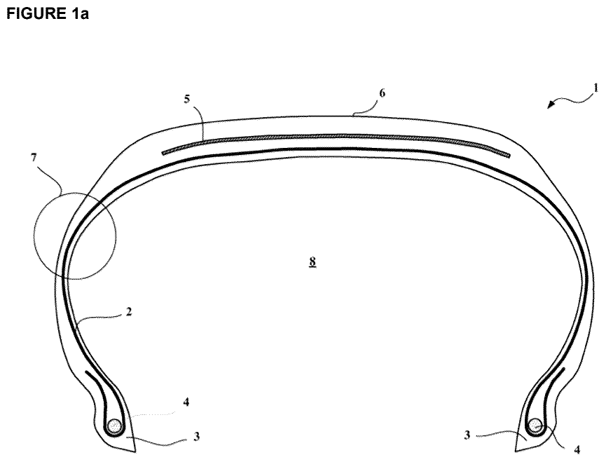

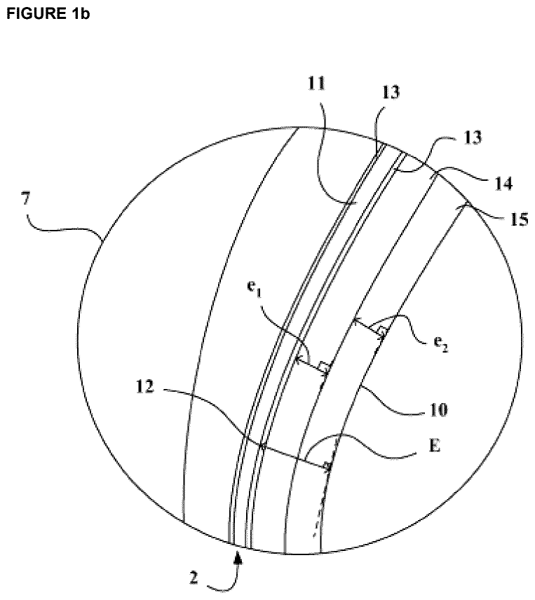

FIG. 1a, a meridian view of a diagram of a tyre according to one embodiment of the invention,

FIG. 1b, an enlarged partial view of a part of the diagram in FIG. 1a.

In order to make them easier to understand, the figures are not shown to scale.

In FIG. 1a and FIG. 1b, the tyre 1, of size 315/70 R 22.5, comprises a radial carcass reinforcement 2 anchored in two beads 3 around bead wires 4. The carcass reinforcement 2 is formed of a single layer of metal cords 11 and of two calendering layers 13. The carcass reinforcement 2 is hooped by a crown reinforcement 5, itself capped by a tread 6.

FIG. 1b illustrates an enlargement of region 7 in FIG. 1a and notably indicates the thickness E of rubber mixture between the internal surface 10 of the cavity 8 of the tyre and the point 12 of a reinforcing element 11 closest to said surface 10. This thickness E is equal to the length of the orthogonal projection of the point 12 of a reinforcing element 11 that is closest to said surface 10 onto the surface 10. This thickness E is the sum of the thicknesses of the various rubber mixtures placed between said reinforcing element 11 of the carcass reinforcement 2; it corresponds, on the one hand, to the thickness of the calendering layer 13 radially on the inside of the carcass reinforcement and, on the other hand, to the thicknesses e1, e2 of the various layers 14, 15 of rubber mixture that form the internal wall of the tyre 1. These thicknesses e1, e2 are moreover equal to the length of the orthogonal projection of a point on one surface onto the other surface of the respective layer 14 or 15 in question.

The compositions described above are especially useful for forming the layer of rubber mixture 14 (layer of rubber mixture radially adjacent to the radially innermost layer of rubber mixture 15).

The examples that follow are given by way of illustration. They should not in any case be considered to limit the present invention.

### EXAMPLES

### Measurement Method

### Rheometry:

The measurements are performed at 140 °C with an oscillating-chamber rheometer, in accordance with Standard DIN 53529—Part 3 (June 1983). The change in the rheometric torque as a function of the time describes the change in the stiffening of the composition as a result of the vulcanization reaction. The measurements are processed in accordance with Standard DIN 53529—Part 2 (March 1983).

t0 is the induction period, that is to say the time necessary for the start of the vulcanization reaction.

tα is the time necessary to reach a conversion of α%, that is to say α% of the difference between the minimum and maximum torques of the crosslinked composition.

t99 is therefore the time necessary to reach 99% of the conversion.

Measurements of Reactivity with Oxygen:

7 samples of mixtures with a thickness of 6/10th of a mm are cured at 140 °C for a period of time corresponding to t99.

The oxygen content initially contained in this sample is measured.

The remaining 6 samples are placed in an oven under air at 85 °C for respectively the following ageing times: 3, 5, 7, 10, 12 and 14 d.

The oxygen content contained in each of the 6 aged samples is then measured.

For each of the 7 samples, the fixed oxygen content is calculated: oxygen content measured in aged sample-oxygen content measured in initial sample.

The reactivity with oxygen of the mixture then corresponds to the slope of the straight line linking the fixed oxygen content (in % by mass) to the number of days of ageing at 85 °C in air (in d).

The results are expressed in base 100 relative to the control (the value of 100 is given to the control).

### Measurements of the Oxygen Content:

The cured mixture is introduced into a pyrolysis chamber at a temperature of around 1000 °C, swept by a constant stream of helium.

The pyrolysate passes over a carbon reducer. The oxygen is converted to carbon monoxide. The gases pass over sodium hydroxide and a desiccant to remove acid vapours. The carbon monoxide is separated from the other pyrolysis gases by a chromatographic column and detected by a katharometer.

The oxygen content in the cured mixture is calculated via a calibration curve created with cholesterol. It is expressed in % by mass of the mixture.

### Tensile Tests:

The tests were carried out in accordance with French Standard NF T 46-002 of September 1988. All the tensile measurements were carried out under the conditions of temperature of (100+/−2 °C) and of hygrometry (50+/−5% relative humidity) in accordance with French Standard NF T 40-101 (December 1979).

The elongations at break (EB in %), at 100 °C+/−2 °C, were measured in accordance with Standard NF T 46-002 on samples cured at 140 °C for 50 minutes.

The above test is carried out on the one hand in the initial state and on the other hand after accelerated thermal-oxidative ageing of 14 days, the sample of tested composition then being placed in a ventilated oven kept at a temperature of 77 °C and under an ambient humidity of 40%.

### Preparation of the Compositions

The compositions are manufactured in appropriate mixers using two successive preparation phases that are well known to those skilled in the art: a first phase of thermomechanical working or kneading (sometimes referred to as a “non-productive” phase) at high temperature, up to a maximum temperature of between 110 °C and 200 °C, preferably between 130 °C and 180 °C, followed by a second phase of mechanical working (sometimes referred to as a “productive” phase) at lower temperature, typically less than 110 °C, for example between 60 °C and 100 °C, during which finishing phase the crosslinking or vulcanization system is conventionally incorporated.

The curing is carried out at 140 °C for 50 min for mixtures 1 to 5.

The prepared mixtures are as described in Table 1 (components and content-unless otherwise indicated, the contents are expressed in phr).

TABLE 1
prepared mixtures

| | | ML1 | ML2 | ML3 | ML4 | ML5 |
|---|---|---|---|---|---|---|
| Elastomer | NR | 100 | 100 | 100 | 100 | 100 |
| Carbon black | | 37 | | | | |
| (grade 500) | | | | | | |
| Pyrolysis carbon black | | | 47.3 | 47.3 | 47.3 | 47.3 |
| (“P550” from Scandinavian | | | | | | |
| Enviro Systems) | | | | | | |
| Cobalt naphthenate | | 0.08 | 0.075 | 0.074 | 0.073 | 0.073 |
| expressed in number of | | (1.5) | (1.5) | (1.5) | (1.5) | (1.5) |
| grams of cobalt per 100 g of | | | | | | |
| mixture | | | | | | |
| (equivalent phr) | | | | | | |
| Resin | | 1 | 1 | 1 | 1 | 1 |
| “Impera R1507” Eastman | | | | | | |
| Vulcanization | Sulfur | 5.8 | 5.8 | 5.8 | 5.8 | 5.8 |
| system | TBBS | 0.6 | 0.6 | 0.6 | 0.6 | 0.6 |
| | Stearic acid | 0.5 | 0.5 | 0.5 | 0.5 | 0.5 |
| | ZnO | 5 | 5 | 5 | 5 | 5 |

To the components listed above are added one or more antioxidants in the following proportions (Table 2):

TABLE 2
nature and content of antioxidant in the mixtures

| | ML1 | ML2 | ML3 | ML4 | ML5 |
|---|---|---|---|---|---|
| 6PPD | 0.66 | 0.61 | 0.83 | 0.61 | 0.61 |
| | (1) | (1) | (1.35) | (1) | (1) |
| expressed in number | | | | | |
| of grams per 100 g of | | | | | |
| mixture | | | | | |
| (equivalent phr) | | | | | |
| TMQ | | | | 0.46 | 1.2 |
| expressed in number | | | | (0.75) | (2) |
| of grams per 100 g of | | | | | |
| mixture | | | | | |
| (equivalent phr) | | | | | |

Mixture ML1 is a control mixture.

Mixtures ML3, ML4, ML5 are mixtures according to the invention.

### Results:

The properties of the mixtures are presented in Table 3.

TABLE 3
properties of the mixtures

| | ML1 | ML2 | ML3 | ML4 | ML5 |
|---|---|---|---|---|---|
| Reactivity | 100 | 141 | 103 | 103 | 102 |
| with oxygen | | | | | |
| at 85°C | | | | | |
| (Base 100 | | | | | |
| vs. ML1) | | | | | |
| t0 (min) at | 7.26 | 9.17 | 8.97 | 9.11 | 9.15 |
| 140 °C | | | | | |
| Initial | 403% | 565% | 544% | 598% | 574% |
| elongation at | | | | | |
| break at | | | | | |
| 100 °C | | | | | |
| Elongation | 143% | 116% | 126% | 139% | 187% |
| at break at | | | | | |
| 100 °C after | | | | | |
| placing in an | | | | | |
| oven for | | | | | |
| 14 d at 77 °C | | | | | |
| under air | | | | | |

It can be observed that mixtures ML3, ML4 and ML5 comprising a total content of antioxidants greater than the commonly used contents (ML1 and ML2) have better resistance to thermal-oxidative degradation than mixture ML2 without reducing the ability thereof to react with oxygen and without reducing the curing to of the mixture.

1.-13. (canceled)

14. A tire having a radial carcass reinforcement made up of at least one layer of reinforcing elements, the tire comprising a crown reinforcement, itself capped radially by a tread, the tread being joined to two beads via two sidewalls,
wherein the tire comprises, between the reinforcing elements of the carcass reinforcement and the cavity of the tire, a rubber mixture, the rubber mixture comprising a composition based on:
an isoprene elastomer;
40 to 70 phr of reinforcing fillers, including at least 10 phr of pyrolysis carbon black;
a crosslinking system; and
0.7% to 4% by mass, relative to the total mass of the composition, of one or more antioxidants.

15. The tire according to claim 14, wherein the isoprene elastomer is selected from the group consisting of natural rubber, synthetic polyisoprenes, isoprene copolymers, and mixtures thereof.

16. The tire according to claim 14, wherein the isoprene elastomer consists of 70 to 100 phr of natural rubber and of 0 to 30 phr of synthetic polyisoprenes.

17. The tire according to claim 14, wherein the pyrolysis carbon black has an ash content ranging from 5% to 30% by weight relative to a total weight of the pyrolysis carbon black.

18. The tire according to claim 14, wherein the pyrolysis carbon black has a sulfur content of greater than 2% by weight relative to a total weight of the pyrolysis carbon black.

19. The tire according to claim 14, wherein the pyrolysis carbon black has a zinc content of greater than or equal to 2% by weight relative to a total weight of the pyrolysis carbon black.

20. The tire according to claim 14, wherein the crosslinking system is a vulcanization system based on molecular sulfur and/or on a sulfur-donating agent.

21. The tire according to claim 20, wherein the vulcanization system comprises between 0.5 and 12 phr of sulfur.

22. The tire according to claim 20, wherein the vulcanization system comprises between 0.1 and 10 phr of one or more vulcanization accelerators.

23. The tire according to claim 20, wherein the vulcanization system comprises between 1 and 10 phr of one or more vulcanization activators.

24. The tire according to claim 14, wherein the composition further comprises one or more agents selected from the group consisting of plasticizers, non-reinforcing fillers, pigments, green tack promoting agents, pro-oxidant metal salts, protective agents, chemical anti-ozonants, anti-fatigue agents and reinforcing resins.

25. The tire according to claim 14, wherein the composition further comprises one or more pro-oxidant metal salts, a content of which determined on the basis of a metal varies from 0.05 to 0.15 g of metal per 100 g of the composition.

26. The tire according to claim 14, wherein the rubber mixture between the reinforcing elements of the carcass reinforcement and the cavity of the tire consists of at least two layers of rubber mixture, a layer of rubber mixture radially adjacent to a radially innermost layer of rubber mixture comprising the composition.
